(19) United States
(12) Patent Application Publication
(10) Pub. No.: US 2008/0288311 A1
(43) Pub. Date: Nov. 20, 2008

(54) Job Referral Network System

(76) Inventor: Vadim Nemtsev, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 12/121,050

(22) Filed: May 15, 2008

Related U.S. Application Data
(60) Provisional application No. 60/938,096, filed on May 15, 2007.

(51) Int. Cl. G06F 9/44

(52) U.S. Cl. 705/7

(57) ABSTRACT

A system and software for networking of job seekers and company insiders associated with companies having available job openings, and which provides incentives for the job seekers and the company insiders to work together to secure employment of the job seekers in the available job openings. One category of incentive is a referral bonus offered and paid by job candidates to company insiders. Another category of incentive is a signing bonus offered and paid by company insiders to accepted job candidates.

### PRIORITY CLAIM

I claim priority benefits to U.S. Provisional Patent Application No. 60/938,096 filed 15 May 2007 (Ref: 4679-P0001A) titled “Job Referral Network System.”

### FIELD OF THE INVENTION

The present invention relates to an Internet-based peer-to-peer job referral marketplace which facilitates the networking of job seekers and company insiders associated with companies having available job openings, and which provides incentives for the job seekers and the company insiders to work together to secure employment of the job seekers in the available job openings.

### BACKGROUND OF THE INVENTION

Recently, a number of job search websites, such as Monster.com, revolutionized the recruitment industry and have taken a significant amount of business away from “help wanted” sections of newspapers. These online job boards have been a major improvement over the old-fashioned way of matchmaking employers and job seekers; through which companies receive thousands of resumes, and candidates can pick from and apply for any of the thousands of posted openings nationwide. However, human resources (HR) departments have become disenchanted with the process because every vacancy now draws huge numbers of resumes, most of which are from candidates who are not even remotely qualified, but whose resumes still must be reviewed to locate the resumes of qualified applicants. At the same time, job candidates are increasingly losing their faith in the online job search websites because very few candidates ever actually hear back from employers, even fewer receive an interview or a job offer. Nevertheless, online job boards are one of the most popular places for job seekers to start their job search and for companies to get the word out about their vacant positions.

Employers face many challenges in recruitment. Due to numerous macroeconomic and demographic changes in the job hunting population, employers are increasingly experiencing difficulty finding and attracting talent. HR departments are understaffed and burdened with multiple functions. They do not have the time or personnel required to sift through thousands of resumes delivered by the Internet, and increasingly rely on referrals from company's employees.

Traditionally, employee referrals have been an effective recruitment method. The reasons for this are several. An existing employee serves a screening function because of self-interest in only referring workers that will (a) enhance the employee's reputation; or (b) work well with the employee.

To provide a financial incentive for their employees to refer candidates, more and more companies offer employee referral programs. Referral bonuses ranging from $100 to $10,000 are paid to employees if their referral turns into a successful hire. Furthermore, some candidates with skills and experience in high demand can even get a signing bonus in the amount of up to $30,000. Employers often conclude that acquiring new hires referred by their own employees is not only cost-effective (by eliminating costs of online job board postings, resume processing, background checking, etc.) but it gets employees more involved in the business development process (they look for the right candidates, do the pre-selection and coaching of people they refer).

Employees would like to take advantage of the referral programs and receive bonuses offered by their companies. The problem is that company insiders have only a limited circle of family members, friends, former classmates and coworkers to choose from. But to find a person that would have the right qualifications, be immediately available and interested in applying for the job is even more challenging. There are thousands of open positions that include a referral bonus offering. But where can an ordinary person find a pool of candidates big and diverse enough to select and refer the right people for those vacancies to be able to collect the bonus? Surprisingly, with such a divide between job seekers and employers, and insider referrals being a proven excellent recruitment channel, there is not much offered in terms of services facilitating the job referral process.

Job hunters also face significant challenges in finding work. It is a popular view that applying for jobs via online job boards equates to sending your resume into a “black hole.” Looking for employment, people turn to their offline and online network of contacts. However, networking requires a significant time investment and strong social skills. Building relationships takes a lot of enthusiasm and persistence.

There currently exist providers of back-end software solutions for tracking referrals once they were submitted by insiders to their employers. However, these providers do not meet the needs of everyone involved in the recruitment process. They are in the business of providing software solutions for referral processing, not referral generation.

Also, there have been companies that made an attempt to operate in the up-stream part of the referral process. They tried to make money by acting as brokers between job seekers and employers. Those brokers wanted to facilitate the referral process and get paid a cut of the referral bonus in case of successful hire. None of these entities have remained in business, and most are now no longer in operation. Employers were unwilling to engage a middleman, pay a hefty commission for its services, and give it direct access to employers' HR databases and information systems.

There are hundreds of business-to-business (b2b) vendors serving employers' recruitment needs. They provide such products and services as HRIS (Human Resources Information System) software, background checks, drug testing, personality assessment, and so on. However, not many companies effectively satisfy the needs of the other side of the recruitment equation—the job seeker. People looking for jobs have a limited choice of user-friendly and effective services. They are considerably underserved as compared to employers, even in the current seller's market.

It is a primary object of the present invention to provide a new job referral marketplace and pioneer a peer-to-peer (p2p) recruitment community, which will empower candidates by giving them control of their job search process.

### SUMMARY OF THE INVENTION

The present invention provides a system and software for a large, well organized and properly designed marketplace for job referrals, by providing a system and method which facilitates the networking of job seekers and company insiders associated with companies having available job openings, and which provides incentives for the job seekers and the company insiders to work together to secure employment of the job seekers in the available job openings. Several scenarios allowing job seekers, company insiders and companies to network with one another with the ultimate goal of matching job seekers with appropriate positions, with various types of incentives, are provided. Eight such scenarios are illustrated on the attached tables. These scenarios can be generally broken down into two categories.

### Referral Bonus Offered/Paid by Candidates to Insiders

In this first category, the above-mentioned incentive takes the form of referral bonuses offered and paid by candidates (i.e., job seekers) to company insiders. It should be noted that further incentives may exist for the various parties in addition to those envisioned to be part of the inventive system and method, such as referral bonuses paid directly from the company to the insider (as are already known).

Four scenarios fitting into this first category are currently envisioned (numbered as Scenarios 1-4 on the attached tables), although it should be recognized that other scenarios, or modifications to these four scenarios, may be employed without departing from the scope and spirit of the present invention. In Scenario 1 the candidates (i.e., job seekers) create their own job postings on the inventive website, while in Scenario 2 candidates search jobs posted by insiders, in Scenario 3 candidates search jobs posted by employers, and in Scenario 4 candidates search for and contact insiders directly. More detail concerning each of Scenarios 1-4 are shown on the attached tables, in which it should be recognized that “TugLink.com” refers to a website in accordance with the present invention. It should also be recognized that it is well within the skill of any technician to program a website embodying the attached tables.

### Signing Bonus Offered/Paid by Insiders to Candidates

In this second category, the above-mentioned incentive takes the form of signing bonuses offered and paid by insiders to candidates. These signing bonuses may, for example, be a portion of referral bonuses paid directly from the company to the insider (as are already known).

Four scenarios fitting into this first category are currently envisioned (numbered as Scenarios 5-8 on the attached tables), although it should be recognized that other scenarios, or modifications to these four scenarios, may be employed without departing from the scope and spirit of the present invention. In Scenario 5 the insiders create their own job postings on the inventive website, while in Scenario 6 insiders search jobs posted by candidates, in Scenario 7 insiders search jobs posted by employers, and in Scenario 8 insiders search for and contact candidates directly. More detail concerning each of Scenarios 5-8 are shown on the attached tables, in which it should be recognized that “TugLink.com” refers to the website in accordance with the present invention. It should also be recognized that it is well within the skill of any technician to program a website embodying the attached tables.

The system and method of the present invention may employ any one of the scenarios described above, but preferably employs a plurality of (and possibly all of) the described scenarios to provide numerous options from which users of the inventive system and method to choose.

TABLE 1
SCENARIO 1: Candidates make their own job postings

Step 1: To find a new job, a job-seeker registers on TugLink.com as Candidate.

[symbol]

Step 2: Candidate finds info about a job that he/she would like to be hired for. This info can be found anywhere - online
job boards, corporate web sites, newspaper classifieds, etc.

[symbol]

Step 3: Candidate posts info about the job on TugLink.com. Candidate includes the job description (e.g. Marketing
Manager, Coca-Cola Inc, Atlanta GA, Job Responsibilities & Requirements info, etc) and announces a Referral Bonus to
the target company's Insiders (i.e. any Coca-Cola employee) for their help with introduction of Candidate to Insider's
Employer (i.e. Coca-Cola HR staffers or hiring managers). The referral bonus can be in any amount that Candidate is
prepared to pay out (e.g. $200 or $1,000). It is an incentive that serves the purpose of rewarding Insiders for their
time/effort and is paid only if and after Candidate gets hired by Employer for the position of interest as a result of Insider's
help.

[symbol]

Step 4: Any Insiders at the target Company (i.e. Coca-Cola employees) registered on TugLink.com web site can view
Candidate's posting. They would compare the job description/requirements with Candidate's background (candidate's
profile includes his photo, video, resume, other relevant info). If Insiders see a strong match and are satisfied with the
referral bonus amount offered by the Candidate, they can offer to provide a referral.

[symbol]

Step 5: When Insider offers a referral to Candidate and Candidate agrees to accept a referral from this Insider, it's
considered that “a tuglink is established”. After that, Insider can meet Candidate (in person, over the phone, by email, etc)
to learn more about his/her background, to provide some info about the job), the Employer's company culture, and,
possibly, give job interview tips.

[symbol]

Step 6: Insider passes Candidate's resume on to Employer (the company's HR staffers and/or the hiring manager for this
job).

| | | |
|---|---|---|
| [symbol] | [symbol] | [symbol] |
| Step 7a: The Candidate never | Step 7b: The Candidate is | Step 7c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and referral bonus deal is not | and Candidate was established. | and Candidate was established. |
| effective anymore (even if the | Outcome - the tuglink expires | Outcome - the Candidate pays |
| Candidate eventually gets | and referral bonus deal is not | the Insider the agreed-upon |
| hired). | effective anymore (even if the | referral bonus within the |
| | Candidate eventually gets | predetermined (by TugLink) |
| | hired). | number of days (say, 30 days |
| | | after hire). |

TABLE 2
SCENARIO 2: Candidates search jobs posted by Insiders

Step 1: To assist job-seekers (Candidates) in their job search and to help his/her organization (Employer) hire the right
Candidates, a company employee registers on TugLink.com as Insider.

[symbol]

Step 2: Insider posts info about job openings at his Employer (e.g. Coca-Cola) on TugLink.com. He includes job
description (e.g. Marketing Manager, Coca-Cola Inc, Atlanta GA, Job Responsibilities & Requirements info, etc) and the
amount of a Referral Bonus that he would like to get for his service of helping with introduction of Candidate to Insider's
Employer (i.e. Coca-Cola HR staffers or hiring managers). The referral bonus can be in any amount that Insider is willing
to receive (e.g. $100 or $500). It is a reward to Insiders for their time/effort and is paid only if and after Candidate gets
hired by Employer for the position of interest as a result of the Insider's help.

[symbol]

Step 3: Any Candidates registered on TugLink.com web site can view Insider's posting. If Candidates are interested in the
job and would like to request Insider's referral, they can ask for a referral.

[symbol]

Step 4: When Insider agrees to provide a referral to Candidate, it's considered that “a tuglink is established”. After that,
Insider can meet Candidate (in person, over the phone, by email, etc) to learn more about his/her background, to provide
some info about the job, the Employer's company culture, and possibly, give job interview tips.

[symbol]

Step 5: Insider passes Candidate's resume on to Employer (the company's HR staffers and/or the hiring manager for this
job).

| | | |
|---|---|---|
| [symbol] | [symbol] | [symbol] |
| Step 6a: The Candidate never | Step 6b: The Candidate is | Step 6c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and referral bonus deal is not | and Candidate was established. | and Candidate was established. |
| effective anymore (even if the | Outcome - the tuglink expires | Outcome - the Candidate pays |
| Candidate eventually gets | and referral bonus deal is not | the Insider the agreed-upon |
| hired). | effective anymore (even if the | referral bonus within the |
| | Candidate eventually gets | predetermined (by TugLink) |
| | hired). | number of days (say, 30 days |
| | | after hire). |

TABLE 3
SCENARIO 3: Candidates search jobs posted by Employers

Step 1: To assist job-seekers (Candidates) in their job search and to help their employees (Insiders) refer Candidates to
their company, a company representative registers on TugLink.com as Employer.

[symbol]

Step 2: Employer (e.g. Coca-Cola) posts info about job openings at the company on TugLink.com. Employer includes job
description (e.g. Marketing Manager, Coca-Cola Inc, Atlanta GA, Job Responsibilities & Requirements info, etc).

[symbol]

Step 3: Any Candidates registered on TugLink.com web site can view Employer's posting. If Candidates are interested in
the job and would like to request Insider's referral, they respond to the posting. In their response to the posting,
Candidates ask for a referral and announce a Referral Bonus to the company's Insiders (i.e. any Coca-Cola employee)
for their help with introduction of the Candidate to the Insider's Employer (i.e. Coca-Cola HR staffers or hiring managers).
The referral bonus can be in any amount that the Candidate is prepared to pay out (e.g. $200 or $1,000). It is an
incentive that serves the purpose of rewarding Insiders for their time/effort and is paid only if and after the Candidate gets
hired by the Employer for the position of interest as a result of the Insider's help.

[symbol]

Step 4: Any Insiders at the target company (i.e. Coca-Cola emoloyees) registered on TugLink.com web site can view their
Employer's postings and Candidates' responses to those postings. Insider, would compare the job
description/requirements in Employer's postings with the background (candidate's profile includes his photo, video,
resume, other relevant info) of those Candidates who responded. If Insiders see a strong match and are satisfied with the
referral bonus amount offered by the Candidate, they can offer to provide a referral.

[symbol]

Step 5: When Insider offers a referral to Candidate and Candidate agrees to accept a referral from this Insider, it's
considered that “a tuglink is established”. After that, Insider can meet Candidate (in person, over the phone, by email, etc)
to learn more about his/her background, to provide some info about the job, the Employer's company culture, and,
possibly, give job interview tips.

[symbol]

Step 6: Insider passes Candidate's resume on to Employer (the company's HR staffers and/or the hiring manager for this
job).

| | | |
|---|---|---|
| [symbol] | [symbol] | [symbol] |
| Step 7a: The Candidate never | Step 7b: The Candidate is | Step 7c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and referral bonus deal is not | and Candidate was established. | and Candidate was established. |
| effective anymore (even if the | Outcome - the tuglink expires | Outcome - the Candidate pays |
| Candidate eventually gets | and referral bonus deal is not | the Insider the agreed-upon |
| hired). | effective anymore (even if the | referral bonus within the |
| | Candidate eventually gets | predetermined (by TugLink) |
| | hired). | number of days (say, 30 days |
| | | after hire). |

TABLE 4
SCENARIO 4: Candidates search/contact Insiders directly

Step 1 : To find a new job, a job-seeker registers on TugLink.com as Candidate.

[symbol]

Step 2: Candidate finds info about a job that he/she would like to be hired for. This info can be found anywhere - online
job boards, corporate web sites, newspaper classifieds, etc.

[symbol]

Step 3: Candidate comes to TugLink.com and searches for Insiders who work for the Employer (e.g. Coca-Cola) where
the target job opening is at. Candidate directly posts info about the job for the attention of the selected Insider (i.e. Coca-
Cola employees). Candidate includes the job description (e.g. Marketing Manager, Coca-Cola Inc, Atlanta GA, Job
Responsibilities & Requirements info, etc) and offers the Insider a Referral Bonus for his/her help with introduction of
Candidate to Insider's Employer (i.e. Coca-Cola HR staffers or hiring managers). The referral bonus can be in any
amount that Candidate is prepared to pay out (e.g. $200 or $1,000). It is an incentive that serves the purpose of rewarding
Insiders for their time/effort and is paid only if and after Candidate gets hired by Employer for the position of interest as a
result of Insider's help.

[symbol]

Step 4: The Insiders who were directly approached by the Candidate can view the Candidate's job posting and request for
referral. Insiders would compare the job description/requirements with Candidate's background (candidate's profile
includes his photo, video, resume, other relevant info). If Insiders see a strong match and are satisfied with the referral
bonus amount offered by the Candidate, they can offer to provide a referral.

[symbol]

Step 5: When Insider agrees to provide a referral to Candidate, it's considered that “a tuglink is established”. After that,
Insider can meet Candidate (in person, over the phone, by email, etc) to learn more about his/her background, to provide
some info about the job, the Employer's company culture, and, possibly, give job interview tips.

[symbol]

Step 6: Insider passes Candidate's resume on to Employer (the company's HR staffers and/or the hiring manager for this
job).

| | | |
|---|---|---|
| [symbol] | [symbol] | [symbol] |
| Step 7a: The Candidate never | Step 7b: The Candidate is | Step 7c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and referral bonus deal is not | and Candidate was established. | and Candidate was established. |
| effective anymore (even if the | Outcome - the tuglink expires | Outcome - the Candidate pays |
| Candidate eventually gets | and referral bonus deal is not | the Insider the agreed-upon |
| hired). | effective anymore (even if the | referral bonus within the |
| | Candidate eventually gets | predetermined (by TugLink) |
| | hired). | number of days (say, 30 days |
| | | after hire). |

TABLE 5
SCENARIO 5: Insiders make their own job postings

Step 1: To assist job-seekers (Candidates) in their job search and to help his/her organization (Employer) hire the right
Candidates, a company employee registers on TugLink.com as Insider.

[symbol]

Step 2: Insider posts info about job openings at his Employer (e.g. Coca-Cola) on TugLink.com. He includes job
description (e.g. Marketing Manager, Coca-Cola Inc, Atlanta GA, Job Responsibilities & Requirements info, etc) and the
amount of a Signing Bonus that he would like to offer to the Candidate who gets sucessfully hired by Insider's Employer.
The signing bonus can be in any amount that Insider is willing to pay (e.g. $100 or $5,000). It is used to attract the
attention of in-demand Candidates with hard to find skills/experience. The signing bonus is paid only if the Candidate gets
hired by Employer for the position as a result of the Insider's help AND after the predetermined (by Insider) number of
days of a trial period (say, 90 days after hire).

[symbol]

Step 3: Any Candidates registered on TugLink.com web site can view Insider's posting. If Candidates are interested in the
job and would like to request Insider's referral, they can ask for a referral.

[symbol]

Step 4: When Insider agrees to provide a referral to Candidate, it's considered that “a tuglink is established”. After that,
Insider can meet Candidate (in person, over the phone, by email, etc) to learn more about his/her background, provide
some info about the job, the Employer's company culture, and, possibly, give job interview tips.

[symbol]

Step 5: Insider passes Candidate's resume on to Employer (the company's HR staffers and/or the hiring manager for this
job).

| | | |
|---|---|---|
| [symbol] | [symbol] | [symbol] |
| Step 6a: The Candidate never | Step 6b: The Candidate is | Step 6c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and signing bonus deal is not | and Candidate was established. | and Candidate was established. |
| effective anymore (even if the | Outcome - the tuglink expires | Outcome - if Candidate passes |
| Candidate eventually gets | and signing bonus deal is not | the trial period (i.e. does not |
| hired). | effective anymore (even if the | leave or get fired within the |
| | Candidate eventually gets | predetermined 90 days after |
| | hired). | hire), the Insider pays the |
| | | Candidate the agreed-upon |
| | | signing bonus. |

TABLE 6
SCENARIO 6: Insiders search jobs posted by Candidates

Step 1 : To assist job-seekers (Candidates) in their job search and to help his/her organization (Employer) hire the right
Candidates, a company employee registers on TugLink.com as Insider.

[symbol]

Step 2: Insider can search and view Candidates' postings requesting referral for jobs at Insider's company. First, Insider
would compare the job requirements with Candidate's background. If Insider sees a strong match, he can choose to
provide a referral and offer a Signing Bonus (paid if Candidate gets sucessfully hired by Insider's Employer).
The signing bonus can be in any amount that Insider is willing to pay (e.g. $100 or $5,000). It is used to attract the
attention of in-demand Candidates with hard to find skills/experience. The signing bonus is paid only if the Candidate gets
hired by Employer for the position as a result of the Insider's help AND after the predetermined (by Insider) number of
days of a trial period (say, 90 days after hire).

[symbol]

Step 3: When Insider offers a referral to Candidate and if Candidate agrees to accept a referral from this Insider, it's
considered that “a tuglink is established”. After that, Insider can meet Candidate to learn more about his/her background,
to provide some info about the job, the Employer's company culture, and, possibly, give job interview tips.

[symbol]

Step 4: Insider passes Candidate's resume on to Employer (the company's HR staffers and/or the hiring manager for this
job).

| | | |
|---|---|---|
| [symbol] | [symbol] | [symbol] |
| Step 5a: The Candidate never | Step 5b: The Candidate is | Step 5c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and signing bonus deal is not | and Candidate was established. | and Candidate was established. |
| effective anymore (even if the | Outcome - the tuglink expires | Outcome - if Candidate passes |
| Candidate eventually gets | and signing bonus deal is not | the trial period (i.e. does not |
| hired). | effective anymore (even if the | leave or get fired within the |
| | Candidate eventually gets | predetermined 90 days after |
| | hired). | hire), the Insider pays the |
| | | Candidate the agreed-upon |
| | | signing bonus. |

TABLE 7
SCENARIO 7: Insiders search jobs posted by Employers

Step 1: To assist job-seekers (Candidates) in their job search and to help their employees (Insiders) refer Candidates to
their company, a company representative registers on TugLink.com as Employer.

[symbol]

Step 2: Employer (e.g. Coca-Cola) posts info about job openings at the company on TugLink.com. Employer includes job
description (e.g. Marketing Manager, Coca-Cola Inc, Atlanta GA, Job Responsibililties & Requirements info, etc).

[symbol]

Step 3: Any Candidates registered on TugLink.com web site can view Employer's posting. If Candidates are interested in
the job and would like to get Insider's referral, they respond to the posting requesting a referral.

[symbol]

Step 4: Any Insiders at the target company (i.e. Coca-Cola emoloyees) registered on TugLink.com web site can view their
Employer's postings and Candidates' responses to those postings. Insiders would compare the job description in
Employer's postings with the background of those Candidates who responded. If Insider sees a strong match, he can
choose to provide a referral and offer a Signing Bonus (paid if Candidate gets sucessfully hired by Insider's Employer).
The signing bonus can be in any amount that Insider is willing to pay (e.g. $100 or $5,000). It is used to attract the
attention of in-demand Candidates with hard-to-find skills. The signing bonus is paid only if the Candidate gets hired by
Employer for the position as a result of the Insider's help AND after the predetermined (by Insider) number of days of a
trial period (say, 90 days after hire).

[symbol]

Step 5: When Insider offers a referral to Candidate and if Candidate agrees to accept a referral from this Insider, it's
considered that “a tuglink is established”. After that, Insider can meet Candidate to learn more about his/her background,
to provide some info about the job, the Employer's company culture, and, possibly, give job interview tips.

[symbol]

Step 6: Insider passes Candidate's resume on to Employer (the company's HR staffers and/or the hiring manager for this
job).

| | | |
|---|---|---|
| [symbol] | [symbol] | [symbol] |
| Step 7a: The Candidate never | Step 7b: The Candidate is | Step 7c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and signing bonus deal is not | and Candidate was established. | and Candidate was established. |
| effective anymore (even if the | Outcome - the tuglink expires | Outcome - if Candidate passes |
| Candidate eventually gets | and signing bonus deal is not | the trial period (i.e. does not |
| hired). | effective anymore (even if the | leave or get fired within the |
| | Candidate eventually gets | predetermined 90 days after |
| | hired). | hire), the Insider pays the |
| | | Candidate the agreed-upon |
| | | signing bonus. |

TABLE 8
SCENARIO 8: Insiders search/contact Candidates directly

Step 1: To assist job-seekers (Candidates) in their job search and to help his/her organization (Employer) hire the right
Candidates, a company employee registers on TugLink.com as Insider.

[symbol]

Step 2: Insider comes to TugLink.com and searches for Candidates whom he could to refer to his Employer (e.g. Coca-
Cola). Insider directly posts info about the job for the attention of the selected Candidate. Insider includes the job
description and offers a Signing Bonus (paid if Candidate gets sucessfully hired by Insider's Employer). The signing
bonus can be in any amount that Insider is willing to pay (e.g. $100 or $5,000). It is used to attract the attention of in-
demand Candidates with hard to find skills. The signing bonus is paid only if the Candidate gets hired by Employer for the
position as a result of the Insider's help AND after the predetermined (by Insider) number of days of a trial period (say, 90
days after hire).

[symbol]

Step 3: When Insider offers a referral to Candidate and if Candidate agrees to accept a referral from this Insider, it's
considered that “a tuglink is established”. After that, Insider can meet Candidate to learn more about his/her background,
to provide some info about the job, the Employer's company culture, and, possibly, give job interview tips.

[symbol]

Step 4: Insider passes Candidate's resume on to Employer (the company's HR staffers and/or the hiring manager for this
job).

| | | |
|---|---|---|
| [symbol] | [symbol] | [symbol] |
| Step 5a: The Candidate never | Step 5b: The Candidate is | Step 5c: The Candidate is |
| hears back from the Employer. | invited by the Employer to | invited by the Employer to |
| Result - the Candidate does | interview with one or more | interview with one or more |
| NOT get hired for the job in the | managers. | managers. |
| predetermined (by TugLink) | Result - the Candidate does | Result - the Candidate DOES |
| number of days (say, 60 days) | NOT get hired for the job in the | get hired for the job in the |
| after the tuglink between Insider | predetermined (by TugLink) | predetermined (by TugLink) |
| and Candidate was established. | number of days (say, 60 days) | number of days (say, 60 days) |
| Outcome - the tuglink expires | after the tuglink between Insider | after the tuglink between Insider |
| and signing bonus deal is not | and Candidate was established. | and Candidate was established. |
| effective anymore (even if the | Outcome - the tuglink expires | Outcome - if Candidate passes |
| Candidate eventually gets | and signing bonus deal is not | the trial period (i.e. does not |
| hired). | effective anymore (even if the | leave or get fired within the |
| | Candidate eventually gets | predetermined 90 days after |
| | hired). | hire), the Insider pays the |
| | | Candidate the agreed-upon |
| | | signing bonus. |

What is claimed is:

1. A system which facilitates the networking of job seekers and company insiders associated with companies having available job openings, which provides incentives for the job seekers and the company insiders to work together to secure employment of the job seekers in the available job openings.

2. The system of claim 1 wherein the incentives comprise referral bonuses offered and paid by the job seekers to the company insiders.

3. The system of claim 1 wherein the incentives comprise signing bonuses offered and paid by the company insiders to the job seekers.
